(19) United States
(12) Patent Application Publication
(10) Pub. No.: US 2002/0154852 A1
(43) Pub. Date: Oct. 24, 2002

(54) Electro-optical waveguide switching method and apparatus

(76) Inventors: Jules D. Levine, Santa Clara, CA (US); Stepan Essaian, San Jose, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/839,237

(22) Filed: Apr. 23, 2001

(51) Int. Cl. G02B 6/35; G02B 6/26

(52) U.S. Cl. 385/16; 385/40

(57) ABSTRACT

Electro-optical waveguide switching method and apparatus includes structure and steps for switching an optical signal from a first waveguide into a second waveguide. Voltage application structure and/or step is provided to apply a differential voltage to the first waveguide to cause an optical signal propagating in the first waveguide to propagate in the second waveguide. The first waveguide core/cladding structure is configured to provide a memory function that substantially maintains the propagation of the optical signal from the first waveguide to the second waveguide after the differential voltage is no longer applied to the first waveguide. Preferably, the switch is a planar array switch having epitaxially-deposited PZT core and PZLT cladding layers. The design makes possible 1000×1000 waveguide array switching on a single substrate.

### BACKGROUND

1. Field of the Invention

The present invention relates to all-optical switching structure and processes; and preferably to an electro-optical switch for a waveguide array, and to methods for coupling light in such a switch. A preferred embodiment is capable of switching, for example, a 1,000×1,000 array of waveguides using electcro-optical actuation, and includes a memory function provided by a ferroelectric hysteresis effect.

2. Related Art

The explosive growth in telecommunications traffic requires switches capable of handling a large number of data channels, such as optical waveguide arrays. Such switches should be able to handle high bitrate traffic to manage DWDM (Dense Wavelength Division Multiplexing) communication systems. At present, commercial electronic switches for optical communications have electrical cores. In such electronic switches, light pulses are converted into electrical signals so that the signal path across the middle of the switch can be handled by conventional application-specific integrated circuits (DCS (Digital Control System) or analog). However, scalability of such electronic switch arrays with respect to the bitrate and the number of ports is a problem.

It appears that state-of-the-art ASIC (Application Specific Integrated Circuit) technology cannot support anything more than 40 GBt/s bitrate and a 512×512-port electronic core. By comparison, all-optical switches such as MEMS (Micro Electro Mechanical Systems) mirror arrays do not suffer these limitations. All-optical switches may also eliminate the need for repeated opticalelectrical-optical (OEO) conversions in the network. In addition, all-optical switches will allow carriers to support higher transmission speeds without upgrading the switching equipment. However, a disadvantage of all optical switches is that they do not have the ability to change wavelength, which currently must be accomplished by separate equipment. Currently, a wide range of different technologies is being studied for use in the core of all-optical switches, for example MEMS, Liquid Crystals, Bubble, Holographic, and Planar Lightwave Circuits.

Planar lightwave circuits appear to have the most potential, since they can be integrated like electronic integrated circuits. Large N×N switches can be formed by integrating basic m×n (m,n=1,2,3, . . .N) components on the same chip or by integrating individual elements in crosspoints of a crossbar switch structure. This technology can be used to build thermo-optic, electro-optic, and acousto-optic switches. Such switches are reliable due to the absence of moving parts, and have switching speeds which vary from nanoseconds (for electro-optic switches), to 10 microseconds (for acousto-optic switches), and to milliseconds (for thermo-optic switches). Current thermo-optic switches are slow and consume about 100 times more power than electro-optic switches. As for acousto-optic switches, a single device typically consumes 0.2-1 W of power, and they are therefore used for single switches or in small switching arrays.

Electro-optical switches use electrically-controlled coupling between two parallel waveguides to transfer the light from one waveguide to the other. N×N crosspoint switching arrays have N² switching elements and at least N² control lines to connect the switches to voltage sources. The maximum size of commercially available electro-optical switch arrays is 8×8 (Granestrand et al, “Pigtailed Tree Structured 8×8 LiNbO3 Switch Matrix with 112 Digital Optical Switches”, IEEE Photonic. Tech Left. Vol 6 71 (1994); incorporated herein by reference), and they are based on the most mature LiNbO₃ PLC (Planar Lightwave Circuit) technology. The 8×8 limitation on the number of switches is primarily due to the large physical dimension of the bend radius, and the requirement for a switch for each optical interconnect in the switch array.

Thus, what is needed is an efficient electro-optical switch array design which allows efficient coupling of 1000×1000 waveguides in a small space with minimal switching loss and ease of control.

### SUMMARY OF THE INVENTION

An object of the present invention is to overcome the limitations in the art noted above, and to provide an efficient switch design capable of large scale integration.

According to a first aspect of the present invention, method and apparatus for switching an optical signal from a first waveguide into a second waveguide include voltage application structure and/or steps to apply a differential voltage to the first waveguide to cause an optical signal propagating in the first waveguide to propagate in the second waveguide. The first waveguide core/cladding structure is configured to provide a memory function that substantially maintains the propagation of the optical signal from the first waveguide to the second waveguide after the differential voltage is no longer applied to the first waveguide. Preferably, the switch is a planar array switch having epitaxially-deposited PZT [Pb(Zr,Ti)O₃] core and PZLT [(Pb,La)(Zr,Ti)O₃] cladding layers. The design makes possible 1000×1000 waveguide array switching on a single substrate.

According to another aspect of the present invention, an optical switching array and switching process includes structure and/or steps whereby a plurality of first waveguides is provided, each said first waveguide having a core and a cladding. A plurality of second waveguides is respectively disposed within optical coupling distance of the first plurality of first waveguides, each said second waveguide having a core and a cladding. Optical coupling structure is disposed adjacent each of said plurality of first waveguides and each of said plurality of second waveguides, for selectively applying voltage to said each of said plurality of first waveguide core and cladding, and to said each of said plurality of second waveguide core and cladding, to cause optical power propagating in said each first waveguide to be switched into an adjacent second waveguide. Each said first waveguide has a core and a cladding configured to provide a memory function at a location where the optical power switches from said each first waveguide to the adjacent second waveguide.

According to a further aspect of the present invention, an optical switch and switching method includes structure and/or steps for providing a first optical waveguide having a core and a cladding, and a second optical waveguide having a core and a cladding. A segmented optical waveguide is provided having a core and a cladding, and is disposed adjacent both said first optical waveguide and said second optical waveguide. The segmented optical waveguide has a first cladding with an index of refraction n_{cb} and a second cladding with an index of refraction n_{c}. Coupler structure and/or step is provided for applying a switching voltage to said segmented optical waveguide which causes a change in the segmented optical waveguide second cladding index of refraction n_{c} to cause optical power propagating in the first waveguide to be switched into the segmented waveguide and to be switched from the segmented waveguide into the second waveguide. Each of said first optical waveguide core, said second optical waveguide core, and said a segmented optical waveguide core comprising one of PZT, PLZT, and BST [Ba(Sr,Ti)O₃].

According to yet another aspect of the present invention, a process of forming an optical switch which switches optical power from a first waveguide (among a plurality of first waveguides) to a second waveguide (among a plurality of second waveguides), comprising the steps of: (i) disposing a bottom metal electrode array pattern on the substrate; (ii) layering a first cladding layer array pattern on the substrate over the first metal electrode layer; (iii) layering a core layer array pattern on the substrate over the first cladding layer; (iv) layering a top cladding layer array pattern on the substrate over the core layer; (v) layering a top metal electrode array pattern on the substrate over the second cladding layer; and (vi) configuring the first and second cladding layers and the core layer to cause a memory function at cross points of the first and second waveguides to cause optical power switched from the first waveguide to the second waveguide to remain propagating in the second waveguide after a switching voltage has been removed or reduced.

### BRIEF DESCRIPTION OF THE DRAWINGS

The present invention will be more easily understood from the following detailed description of the presently preferred embodiments, when taken in conjunction with the Drawings which show:

FIG. 1a is a schematic diagram showing the switching of optical power between two parallel waveguides;

FIG. 1b is a graph showing the relationship between the optical power of the lightwaves propagated in FIG. 1a versus the coupling length;

FIG. 1c is a graph showing the dependence of the power-transfer ratio on the mismatch parameter ΔβLo;

FIGS. 2a and 2b are, respectively, planar and cross-sectional views of the switching element according to a preferred embodiment of the present invention;

FIGS. 3 and 4 are schematic representations of the ferro-optic hysteresis diagrams of the memory function at the cross point of the switching element shown in FIGS. 2a and 2b;

FIG. 5 is a schematic representation of ON and OFF cross points in a notional 3×3 switching array according to the present invention;

FIGS. 6a, 6b, and 6c are, respectively, planar views of the bottom metallization layer, the middle Clad/PZT/Clad layer, and the top metallization layer of the switch depicted in FIGS. 2a and 2b;

FIGS. 7a, 7b, and 7c are, respectively, plan, schematic, and cross-sectional views of an alternative overlay embodiment according to the present invention; and

FIG. 8 is a schematic diagram of a modular build switch architecture according to an embodiment of the present invention.

### DETAILED DESCRIPTION OF THE PRESENTLY PREFERRED EMBODIMENTS

1. Introduction

In general, the proposed PLC circuit of the present invention preferably comprises a core and a cladding respectively composed of two different types of ferro-electric materials. The core material preferably comprises lead zirconium titanate PZT with an index of refraction of about 2.61 (λ=633 nm) (see Nashimoto et al, “Patterning of (Pb,La) (ZrTi)O₃ Waveguide for Fabricating Micro-Optics Using Wet Etching an Solid-Phase Epitaxy”, Appl. Phys. Lett. 75, 1054, (1999); incorporated herein by reference), although core materials having indices of refraction from about 2.40 to about 2.80 may be used . The cladding material preferably comprises lead lanthanum zirconium titanate PLZT with an index of refraction=2.51, or strontium titanate SrTiO₃ (ST) with an index of refraction of 2.40. Like material having indices of refraction of from about 2.30 to about 2.70 may also be used.

These core and cladding materials are preferably used in the present invention to fabricate the proposed opto-electric N×N (N≧100) switch arrays for four reasons:

(a) The large refractive index difference (δ≧0.1) between the PZT core and the PLZT or ST cladding allows the design of a low-loss and abrupt bend channel with the radius of ≦1 mm, since the high −δ waveguides have strong light confinement effects, and therefore a small radius with low losses can be fabricated;

(b) PZT has an electro-optic coefficient much higher than that of LiNbO₃ (G. H. Haetling and C. E. Land, Hot-Pressed (Pb,La)TiO3 Ferroelectric Ceramics for Electrooptic Applications, J. Am. Cerm. Soc. 54, 1 (1971); incorporated herein by reference). This feature makes it possible to switch at lower voltages than is possible with LiNbO₃. These electro-optic coefficients describe how the refractive index varies with applied electric field;

(c) PZT has a refractive index which does not vary linearly with applied voltage but which has a pronounced hysteresis, which provides for a memory function to be described in more detail below. This is a notable feature which allows electrical pulses to be used to address a single optical switch in a switch array. The both transient pulse and sustaining power is low (<1 microwatt), because of the high resistance of PZT and PLZT dielectrics; and

(d) The technology of deposition of high-optical quality epitaxial thin films of PZT (core), PLZT or ST (cladding), and Pt (metallic conductor) on ST, Si and MgO substrates has been fairly well developed (see Yu. Boikov, S. Esayan(Essaian), Z. Ivanov, G Ororsson, T. Claeson, J. Lee and A. Safari, Epitaxial growth and properties of YBCO-PZT-YBCO trilayer structure, Appl. Phys. Lett. 61,528 (1992); and K. Nashimoto, D. Fork and G. Anderson, Solid Phase Epitaxial Growth of PZT Films on SrTiO3 and MgO, Appl. Phys. Lett. 66, 822, (1995); both of which are incorporated herein by reference), as well as the epitaxial stacking and the patterning of these films (see C. S. Ganpale et al, Scaling of ferroelectric properties in thin films, Appl. Phys. Lett, 75, 409, (1999).

The above-described features allow the fabrication of voltage-programmable all-optical N×N crossbar switch arrays with large array size, high packing density, low pulse switching and sustaining power. The present invention provides a decided improvement over other optical switch arrays, which have limitations due to array size, low packing density, switching power, and sustaining power. In addition, devices according to the present invention may be all solid state and operate at room temperature. There are no moving parts, and no temperature changes are required for device operation.

4×4 waveguides and crossbar switching in GaAs/InGaAsK are described in Komatsu et al, “4×4 GaAs/AlGaAs Optical Matrix Switches with Uniform Device Characteristics Using Alternative Δβ Electro-Optic Guided-Wave Directional Couplers”, Journal of Lightwave Technology vol 9(7), 871 (1991) (incorporated herein by reference). However, the electro-optical coefficient for GaAs/InGaAs is about 50× less than in PZT/PLZT.

2. Electro-Optic Switch Design

Electro-optic directional coupled switches are preferred in the present invention because of their simplicity and sufficient bandwidth to wavelength. Using such a switch, it is possible to control the coupling between two parallel waveguides due to the electro-optic effect. In this effect, light is transferred from one waveguide to a closely-spaced parallel waveguide using an applied voltage. Thus, the switching element comprises an electrically-controlled directional optical coupler.

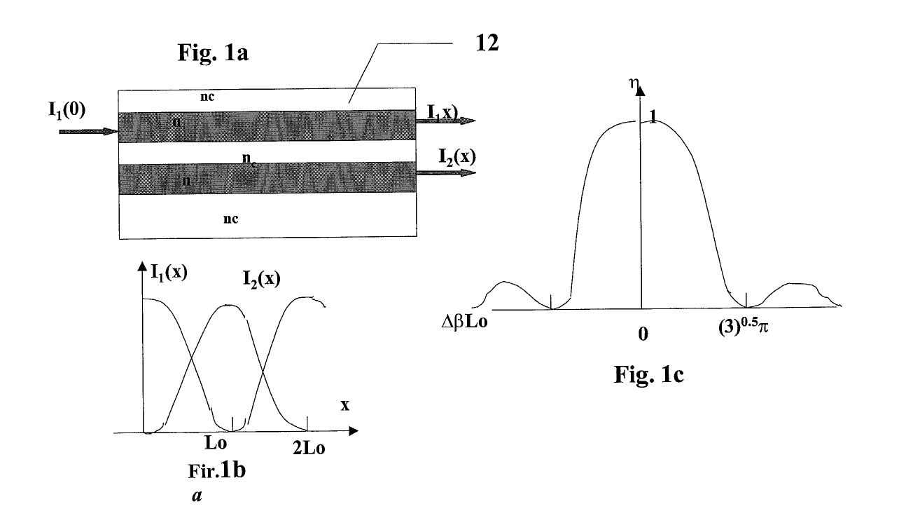

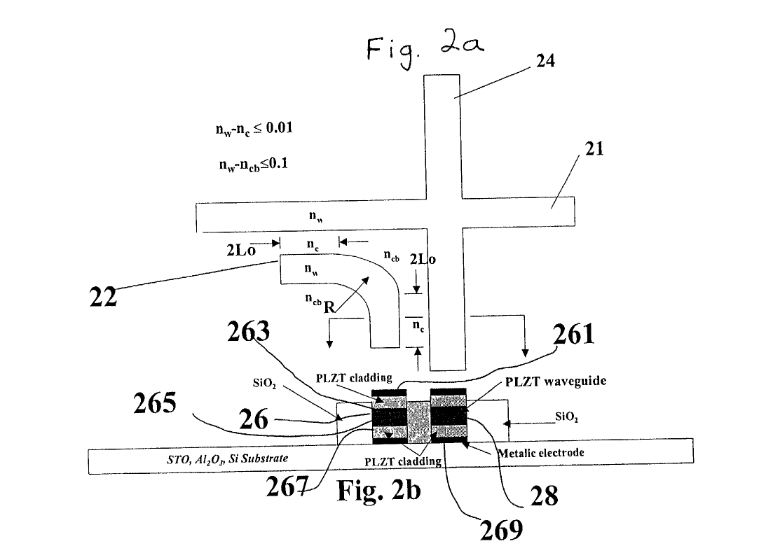

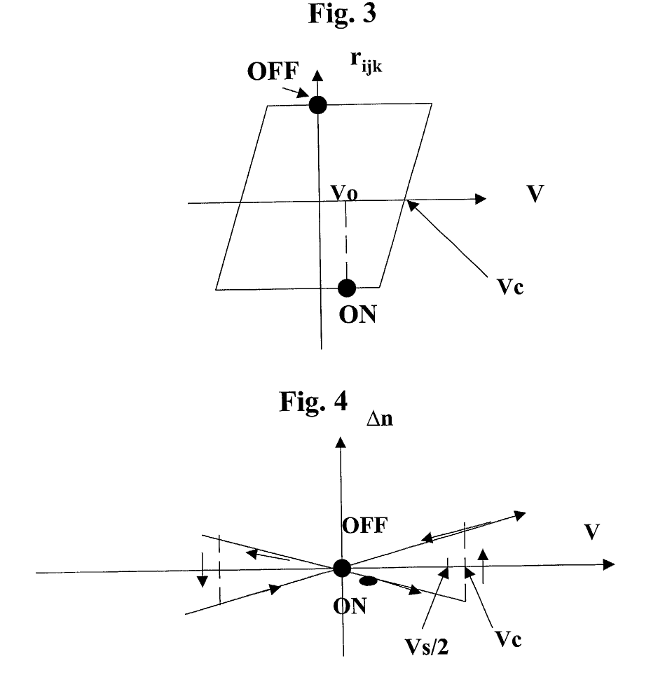

As shown in FIG. a, the optical powers carried by the two waveguides, I₁(x) and I₂(x), can be exchanged periodically along the common direction of propagation x. FIG. 1a also shows two coplanar waveguides with a core 12 having an index of refraction n and a cladding 14 having an index of refraction n_{c}.

The voltage required for switching the optical power depends on the coupling coefficient ξ and the difference in propagation constants Δβ. The coupling coefficient ξ can be written in the approximate form as

ξ=k₁*exp(−k₂*D)/δ (1)

where δ=n₁−n_{c} is the difference between the refractive index n₁ of the waveguide without voltage applied and the refractive index of the cladding n_{c}.

The coupling coefficient exponentially decreases with distance D between the two waveguides because of the evanescent nature of light outside of a waveguide, and it is also inversely proportional to δ. The constants of proportionality are k₁ and k₂, which depend on the wavelength, refractive indices and dimensions.

The difference between the propagation constants in the two coupled waveguides is

Δβ=β₁−β₂=2πn₁/λo−2πn₂/λo=2πΔn/λo (2)

where Δn=n₁−n₂ is the difference between the refractive indices of the two waveguides and is generally a function of applied voltage. For cases of interest, Δn<<n_{c}.

It is preferable to define a particular distance Lo along the waveguide length called the coupling length which is given by

Lo=π/(2ξ) (3)

The power transfer η which is the ratio of the power in waveguide 2 divided by that of waveguide 1 is determined, for example, by the process described in “Introduction To Integrated Optics”, Ed. By M. K. Barnoski, Plenum Press, New York and London, 1974 (incorporated herein by reference), as:

η=(π/2)²sin c²{(½ )[1+(Δβ*Lo/π)²]^{0.5}} (4)

where

sin c(x)=sin(πx)/(πx) (5)

The electro-optic switch has a dimension of Lo, where the coupling between waveguides is maximum and the light intensity from waveguide 1 is zero (I₁(Lo)=0). This is shown at the center of FIG. 1b.

For the purposes of the proposed optimal array design, a dimension 2*Lo is selected, where the coupling intensity is a minimum and the light output from waveguide 2 is zero (I₂(2Lo)=0). This is shown at the far right side of FIG. 1b.

For the case of zero voltage applied to one of the waveguides, Δn =Δβ=0, and Eqns 4 and 5 give ηₘₐₓ=1. This is the condition of maximum power transfer and the optical power exits waveguide 2.

It follows from Eqns 4 and 5 that η has its maximum value of unity at Δβ=0 and decreases with increasing Δβ as seen in FIG. 1c.

The condition of zero power transfer, ηₘᵢₙ=0, in this coupled waveguide requires:

Δβ=(3)^{1/2}π/Lo (6)

as seen from Eqns 4 and 5. By combining Eqns 1 and 6, this gives Δn=(3^{1/2}/2)(λo/Lo) (7)

which is the difference of the indices of refraction corresponding to zero power transfer, and the optical power thus exits waveguide 1.

It follows from the above that optical switches can be designed by manipulating ξ and Δβ, which are functions of Δn. In turn, Δn is a function of the voltage applied accross one of the coupled lines.

It is useful to combine Lo in Eqn 6 with Eqn 3 to derive:

ξ*Lo=k₁*exp(−k₂*D)/δ*(3)^{1/2}Δβ=π/2 (8)

which can be rearranged using Eqn 2 into:

(2πΔn/(δ*λo))*exp(+k₂*D)=k/(3)^{1/2}π (9)

This equation relates the fundamental design quantities of Δn, δ, and the coupling distance Lo.

The class of solutions of this equation involves small values of Δn , δ, and D with correspondingly large values of Î (see “Introduction To Integrated Optics”, Ed. By M. K. Barnoski, Plenum Press, New York and London, 1974; incorporated herein by reference). In the case for LiNbO₃ devices (see L. Thylen, Integrated optics in LiNbO3 : Recent development in device for telecommunications, J. of Lightwave Technology, 6, 847 (1988); incorporated herein by reference), where n₁=n₂=2.225, Δn=0, n_{c}=2.223, D=6 μm, and Lo=0.6 mm. The large value of Lo implies that the packing density of optical switches is relatively low for a given area of electro-optical material.

3. Presently Preferred Switch Design

The present invention utilizes a class of solutions of Eqn 9 with large values of ξ and with correspondingly small values of D˜1 μm.

Using the presently preferred PZT core material, the indices of refraction for the two coupled lines with no voltage applied are n₁=n₂=2.61. Also, the index of refraction of the preferred PLZT cladding material is n_{c}=2.51, so δ≈0.1, and it can be shown by scaling ξ of the PZT/PLZT of compared to LiNbO₃, (Lo≧1 mm) that for this preferred case, Lo≦100 μm.

At present, there are believed to be two practical ways to control Δn:

(a) apply an electric current in an adjacent heater element to raise the temperature of the adjacent waveguide (thermo-optic switching), or

(b) apply an electrical voltage to change n of the adjacent waveguide through an electro-optic effect (electro-optic switches).

Thermo-optic switches may be fabricated on a base of the silica PLC, and because of the small temperature coefficient of the refractive index of silica (≈10⁻⁵/° C.), the required heater power is large (≈0.5 W per switch element). In addition, because of restricted heat sinking, the coupled waveguides should be separated by ≧10 μm, which in turn, will cause the longitudinal dimension Lo of individual switches to be quite large ≈1 cm. This large dimension and power requirements militate against such thermo-optic switches from being preferred in large arrays.

For electro-optical devices, on the other hand, the manipulation of n is based on linear electro-optic effects:

Δnᵢⱼ=−(½)nᵢⱼ³rᵢⱼₖEₖ (10)

where rᵢⱼₖ is the electro-optic tensor and Eₖ is the electric field.

The resulting phase shift is:

Δβ*Lo=Δn(2πLo/λo)=−(πLo/λo)n³rᵢⱼₖ(V/d) (11)

where V is the voltage, and d is the electrode spacing. The voltage Vo necessary to switch the optical power at maximum efficiency is that for which ΔβLo=(3)^{0.5}π, i.e.,

Vo=2*(3)^{0.5}(dλo/Lo n³rᵢⱼₖ)=[2*(3)^{0.5}]ξ*λod/πn³rᵢⱼₖ) (12)

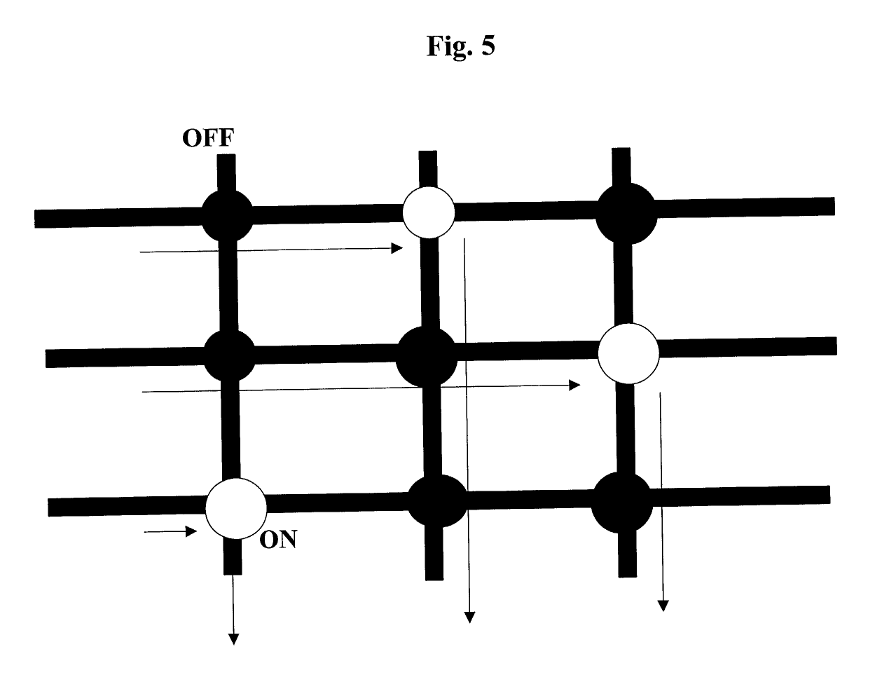

A switch element in a crossbar array is shown in FIGS. 2a and 2b. Here the incident light travelling in a horizontal waveguide 21 passes into a segmented waveguide 22 and then into a vertical waveguide 24, through a number of electro-optic switch elements shown, for example, in cross-section in FIG. 2b as 26 and 28, that are controlled by a differential voltage applied across the switches. Each switch element comprises, for example, a top metallic electrode 261, a PLZT top cladding layer 263, a core layer 265, a bottom PLZT cladding layer 267, and a bottom metallic electrode 269. In the figure is also shown the coupling length Lo, the different materials with core dielectric n_{w}, and two types of cladding materials. Here n_{c} is the cladding material along the coupling length Lo, and n_{cb} is the cladding material elsewhere. For this example, n_{w}−n_{c}≦0.01 and n₁−n_{cb}≦0.1. This example applies to a single mode waveguide. At the cross intersection, the waveguide can be designed to have minimal crosstalk between the vertical and the horizontal waveguides, and minimal insertion loss along the same waveguide. The optical coupling distance between waveguide 21 and segmented waveguide 22 is 1-2 μm, and the optical coupling distance between the segmented waveguide 22 and waveguide 24 is 1-2 μm.

Also shown in FIG. 2b is an elevation depiction of the materials used to fabricate this structure. These will be described later.

From FIGS. 1a and 1b and Eqn 10, it is clear that, at V=0, all optical power exits from waveguide 22 (L=2*Lo, Δβ=0), and when V=Vo (V is the voltage between the electrodes 261 and 269), all of the optical power exits into the second waveguide 24. This phenomenon is used to design the preferred electro-optical switches by using LiNbO3 waveguides (see L. Thylen, J. of Lightwave Technology, 6, 847 (1988).

The coupling constant ξ which is governed by the geometry and refractive indices of waveguides and cladding is an important parameter. To have a small size of the longitudinal extent of the coupler, it is desirable to have a maximum value for ξ. The theory of the directional coupler, as given in Eqn 1, shows that it is inversely proportional to 6.

LiNbO₃ is currently the preferred material in modern electro-optic switching technology. An 8×8 switch is commercially available. Also, 16×16 switches are in development, but there is none in production to date. The limit on the number of switches per unit area is governed by the relatively large physical dimensions of each LiNbO₃ integrated directional coupler. There are two major restrictions for minimizing the size of such switches:

* The LiNbO₃ based planar lightwave circuit (PLC) technology fabrication of waveguide couplers has the minimal value of D≧6 μm, which means that Lo≧1 mm (see L. Thylen, J. of Lightwave Technology, 6, 847 (1988).

Light can be deflected in a waveguide with a bend radius R, as shown in FIG. 2a. Unlike electronic IC's, PLs are compact in only one dimension and this does not allow for the bend radii required for low-loss transmission in a switch array. For example, calculations (see J. J.

Veselka and S. K. Korotky, Optimization of Ti:LiNbO3 optical waveguide directional coupler switches for 1.55 μm wavelength, IEEE J. Of Quantum Electronics, QE-22, 993 (1986); incorporated herein by reference) indicate that for LiNbO₃:Ti waveguides δ=0.01 and for low losses, the bend radius is ≧1 cm.

In practice, the bend radius preferably exceeds Lo, and is the more dominant parameter in attaining high density switch arrays.

4. The Memory Function

To build a large N×N switch array (N>100), the control system should be optimized. Light beams should be switched from one waveguide to the other and maintained over time, temperature changes, and vibrations. There are N² of these switches and this requires at least N² control lines which is very cumbersome for large values of N. The control situation can be simplified if the switching element has a memory or a memory function.

Therefore, the presently preferred embodiment includes switch materials with a memory. These materials preferably comprise ferroelectrics such as PZT, PLZT, and BaSrTiO₃ (BST), and are preferably used in the core of the device. They will be shown to provide a field-programmable all-optical switch with built-in nonvolatile memory. These materials are transparent for λo=0.5−4.0 μm, which is the range of interest in optical communications and they possess hysteresis in rᵢⱼₖ vs V when the spontaneous polarization (P) direction is reversed by the applied electrical voltage.

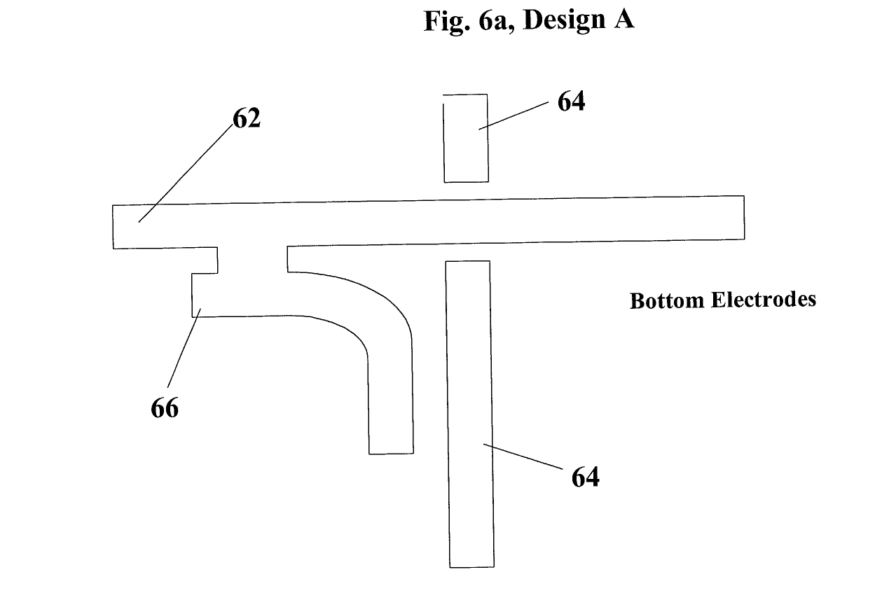

Linear electro-optical effects cause a hysteresis behavior of index of rᵢⱼₖ versus electric field E, as shown in FIG. 3. This diagram shows an idealized square hysteresis curve with positive and negative branches as shown. This phenomena is used to construct an optical switch element with memory. The OFF and ON operating points are shown in the figure.

The index of refraction is related to rᵢⱼₖ by

n₁=no−(½)rᵢⱼₖE negative branch (13)

n₂=no+(½)rᵢⱼₖE positive branch (14)

A plot of Δn=n₁−n₂ versus V=E*d is shown in FIG. 4. This is a more complex graph than FIG. 3, because rᵢⱼₖ in FIG. 4 is multiplied by the abscissa E. In this figure, n₁ corresponds to the negative branch of FIG. 3 and n₂ corresponds to the positive branch of FIG. 3. The ON operating point lies on the negative branch and the OFF operating point lies at the origin. Switching voltages Vs/2 are shown on the diagram, both for the horizontal and vertical electrodes. The offset voltage is Vo. As one example, Vs=5 v and Vo=1 v.

The difference between n₁ and n₂ is just Δn, as defined in Eqn. 2. Vo is the DC voltage which creates the phase difference which is necessary for switching as shown in Eqn. 12. Vc is the coercive voltage which is a measure of the hysteresis effect. For example, for 1 μm thick PZT film Vc=3V , Vs/2<Vc is the magnitude of the switching voltage applied to the vertical and horizontal electrodes at each switch, such that when a particular switch is selected, the total voltage across the switch is Vs.

When operating at the ON state a DC voltage of Vo is preferred.

When switching to the OFF state, a combination of positive horizontal and negative vertical pulses gives a net switching voltage of (Vs/2−(−Vs/2))=Vs, and this transforms rᵢⱼₖ from the negative branch to the positive branch as seen in FIG. 3. Also, this transforms n from the negative branch to the positive branch (DC voltage is removed) as seen in FIG. 4. Thus, the present invention, through judicious choice of materials, provides a memory function at the cross point switch locations.

When switching again to the ON state, the DC voltage is on, and a combination of negative horizontal and positive vertical pulses gives a net switching voltage of (−Vs/2−Vs/2)=−Vs, and this transforms rᵢⱼₖ from the positive branch to the negative branch, as seen in FIG. 3. Also, this transforms n from the positive branch to the negative branch as seen in FIG. 4.

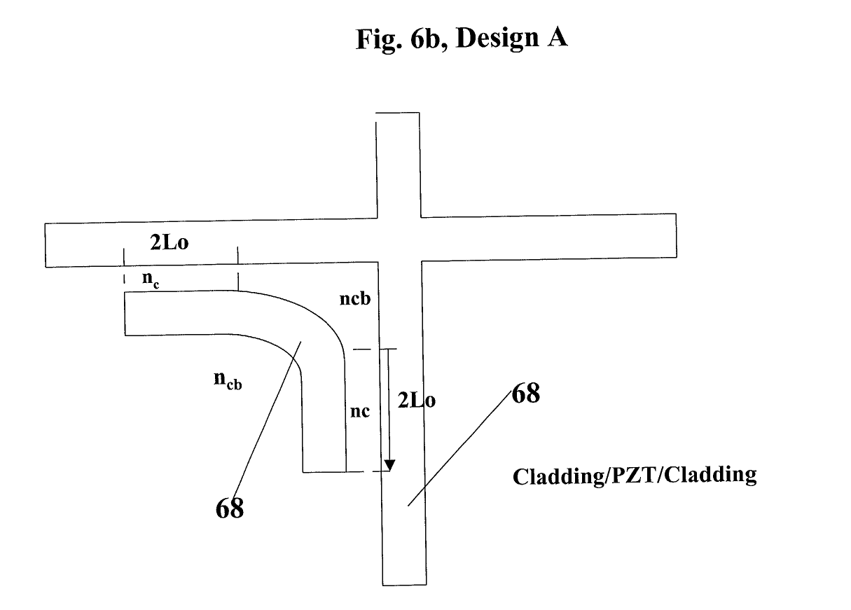

The switching performance for a 3×3 switch array is shown in FIG. 5. It is seen that for switches in the OFF state, the light passes undeflected, whereas for switches in the ON state, the light changes direction at right angles through the coupling elements. In the figure, the ON switches occur at the first row second column, second row third column, and third row first column. It should be recalled that no voltage is needed to sustain the OFF state, that a small sustaining voltage Vst=1V may be provided to more positively sustain the ON state, and that pulse voltages are used to change from the ON state to the OFF state, and vice versa.

By employing this architecture, it is possible to solve the high wiring complexity required for the individual addressing of each switching element in the array. For example, in an array of 32×32 switches, each of the 1024 elements can be individually addressed using only 32 switches attached to the horizontal input lines, and 32 switches attached to the vertical output lines.

5. Fabrication Technology

The technology of deposition, metallization, and etching of PZT, PLZT, BST and ST thin films (epitaxial and polycrystalline) on Si, MgO and ST substrates has been developed for the ferroelectric memory and DRAM applications (see D. E. Kotecki et al, (Ba,Sr)TiO3 dielectrics for future stacked capacitor DRAM, IBM J. Res&Develop.,43(3), 367(1999); incorporated herein by reference). This technology can be used for fabrication-scalable and bitrate-transparent all-optical switches as well. These types of switches will have switching speed of 10⁻⁷ S, which is mainly due to the switching time of ferroelectric polarization.

To fabricate a switching device it is preferred to have metal layers, cladding layers, and core layers, all preferably grown epitaxially on a substrate. Preferred substrates are ST, sapphire, or Si; preferred metal layers are Pt; preferred cladding layers are PLZT or ST; and the preferred core layer is PZT.

The heterostructure of PLZT/PZT/ST is very favorable for constructing the PLC-based active elements, including switches. The refractive index of materials can be tuned from 2.60 for PZT to 2.50 for PLZT by changing the concentration of lanthanum from 0% to 6%. This provides the flexibility of designing compact switches through tuning the difference of refractive index between cladding and core. This difference is preferably a minimum ≦0.01 using PZT core and PLZT cladding, and is preferably a maximum ≧0.1 between PLZT core and ST cladding.

Using Eqns 11 and 12, it can be shown that a PLZT/ST waveguide with 1% refractive index difference between core and cladding offered a 0.2 mm bend practically without loss (≈0.1 dB) at the 1.55 μm wavelength. Both PLZT and BST are dielectric materials, so the switching current is extremely low and therefore the switching power is low as well, ≦1 μW.

There are two presently preferred embodiments, Designs A and B, which show the desired effects of a dense optical array with matrix addressing and memory.

6. Design A

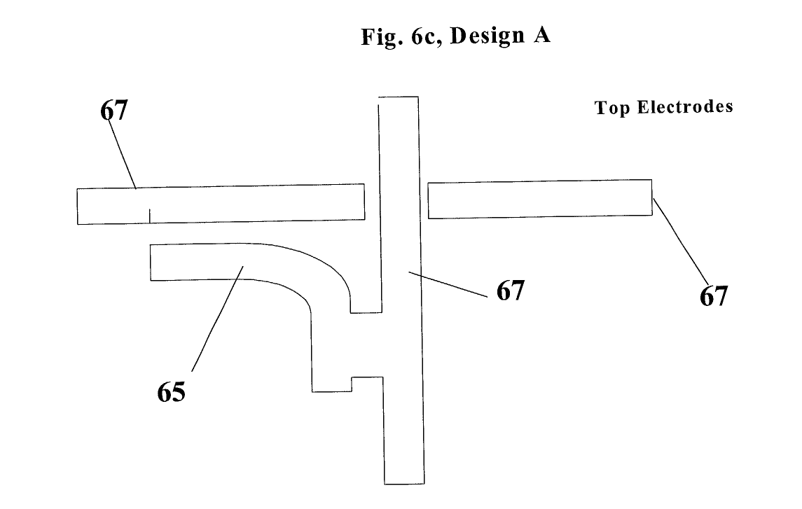

One means to arrange the layers to fabricate a switch array is shown in FIGS. 6a, 6b, and 6c. Here, the substrate can be ST, sapphire, or Si. The metallization pattern is shown in FIG. 6a. This pattern comprises Pt metal which is deposited epitaxially on these substrates to about 0.1 um thickness, and then patterned using lithography. The width of the pattern is preferably 2-5 um. The figure also shows continuous horizontal Pt lines 62 and segmented vertical Pt lines 64. Attached to each horizontal line is an electrical switch coupler 66 whose length is 2*Lo on both the horizontal and vertical axes and whose radius of curvature is R.

The optical stack of cladding/core/cladding is shown in FIG. 6b. This stack is obtained by epitaxial deposition of cladding/core/cladding materials, and then patterning the stack using lithography. Each cladding layer is preferably 0.3 -0.5 um thick, and the core layer is preferably 0.5 -2 um thick. Subsequent to patterning, cladding materials are applied as a backfill into the interstices between the stack layers. This is preferably done in two steps, since the cladding material has two indices of refraction; n_{c} is the refractive index adjacent to the coupling length 2Lo and n_{cb} is the refractive index of the cladding elsewhere. The upper cladding layer covers all of the metallization and the optical stack with a very thin upper layer. The cladding layer with nc can be fabricated by, for example, deposition of PLZT films with low concentration of La (e.g.<1%), and the cladding layer can be deposited with higher concentrations of n_{cb}, for example, 6%.

Finally, Pt metal is deposited and in a pattern shown in FIG. 6c. This is similar to that in FIG. 6a, except that the vertical lines are relatively continuous, and the horizontal lines are segmented. Also attached to each vertical line is an electrical switch coupler 66 whose length is 2*Lo on both the horizontal and vertical axes and whose radius of curvature is R, for example ≦1 mm.

This design uses high quality epitaxial structure to minimize crosstalk at the crosspoint. Should this be a problem, then another design is proposed, Design B.

7. Design B

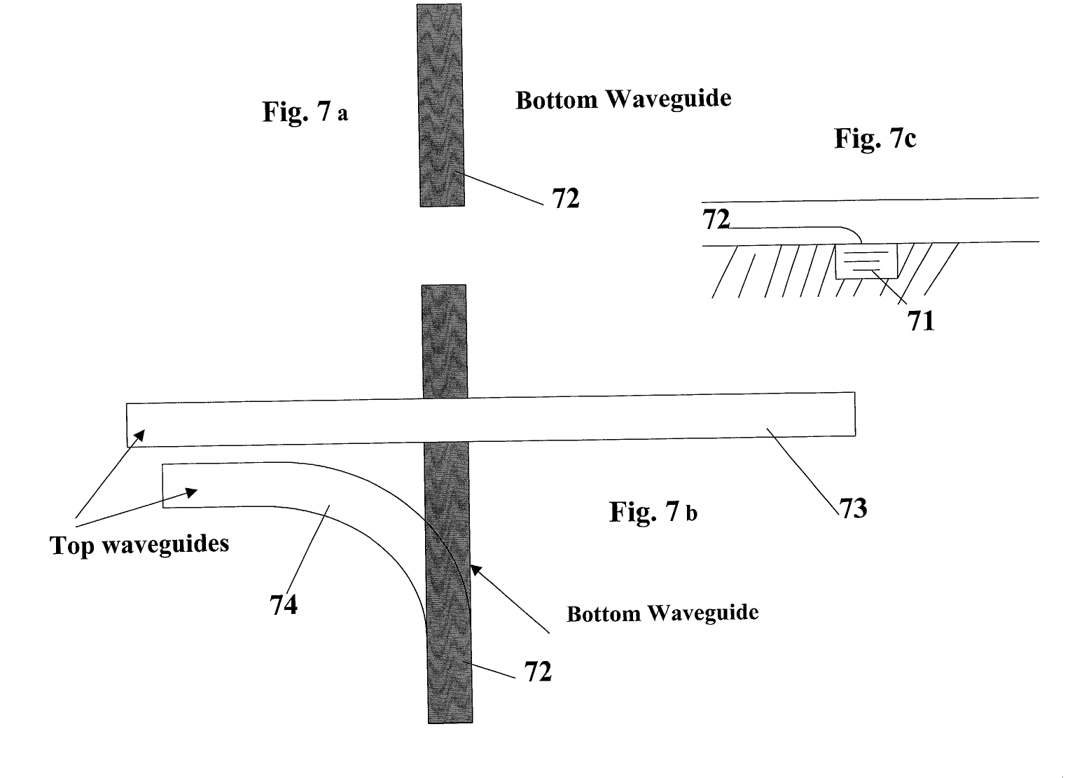

One means to arrange the layers to fabricate a switch array is shown in FIGS. 7a, 7b, and 7c. Here the substrate can be ST, sapphire, or Si.

First, a slot 71 is etched into the substrate, as shown in FIGS. 7a and 7c. Into the slot is deposited a vertical waveguide in the order Pt/cladding/core/cladding similar to that of Design A. Alternatively, it is possible to create a homogeneous deposition of Pt/cladding/core/cladding materials, etch out the pattern, and use chemical/mechanical polishing (CMP) to planarize the structure. The net result is shown in FIG. 7a.

Next, a horizontal waveguide 74 with coupler layers Pt/cladding/core/cladding/Pt can be created in a second plane through deposition and etching as shown in FIG. 7b, so as to overlay the waveguide 72.

An advantage of design B is that there is relatively no crosstalk at the crosspoint.

8. Array Size

Using designs A or B, at a switch size (pitch between switches) of 0.03 cm×0.03 cm, a 100×100 array of nonblocking crossconnect switches can be fabricated on 5 cm×5 cm ST, sapphire, or Si substrates.

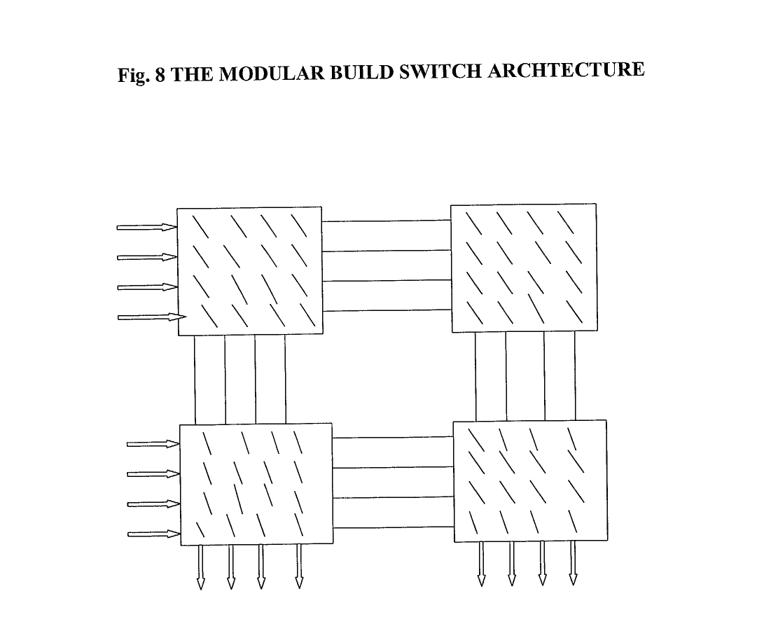

A larger size switch, for instance 1000×1000, can be built by tiling or stacking 100 of the 100×100 arrays. An example of a 2×2 tiling is shown in smaller blocks of m×n switches (m=n=100), as is shown in FIG. 8. The tiling is accomplished by fiber connections between the tiles. Vertical stacking may be used to carry out optical switching in the x, y, and z directions. Also, light signals can be split among two or more adjacent waveguides. For example, a light signal propagating in one waveguide may be switched to one or more adjacent waveguides above, below, or on either side of the waveguide. Even three-dimensional diagonal switching is contemplated within the scope of the present invention.

8. Conclusion

Thus, what has been described is an all-optical, electrical field programmable a switching device with memory scalable to 1000×1000. The switching element of the device is preferably based on the electro-optic effect of PLZT or BST ferroelectric materials. Each switch element in the array occupies a small area 0.03 cm×0.03 cm, with a switching speed of 100 ns, and is capable of high manufacturing yield. The memory feature of the proposed switching elements greatly simplifies the addressing circuitry.

The individual components shown in outline or designated by blocks in the attached Drawings are all well-known in the optical switching arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. Apparatus for switching an optical signal from a first waveguide into a second waveguide, comprising:
voltage application structure to apply a differential voltage to the first waveguide to cause an optical signal propagating in the first waveguide to propagate in the second waveguide; and
the first waveguide comprising a core/cladding structure configured to provide a memory function that substantially maintains the propagation of the optical signal from the first waveguide to the second waveguide after the voltage application structure no longer applies the differential voltage to the first waveguide.

2. Apparatus according to claim 1, wherein, after the voltage application structure no longer applies the differential voltage to the first waveguide, the voltage application structure applies a sustaining voltage to the first waveguide to maintain the propagation of the light signal from the first waveguide to the second waveguide, wherein the sustaining voltage is less than the differential voltage.

3. Apparatus according to claim 1, wherein each of the first and second waveguides comprises a PZT core and a PLZT cladding.

4. Apparatus according to claim 3, wherein said voltage application structure comprises a coupler disposed adjacent each of said first and second waveguides, each coupler comprising top and bottom metal electrodes respectively disposed on opposite sides of the PLZT cladding.

5. Apparatus according to claim 4, wherein the PZT core and the PLZT cladding each comprises an epitaxial layer.

6. Apparatus according to claim 1, wherein the first waveguide includes two cladding regions which have different indices of refraction n_{c} and n_{cb}.

7. Apparatus according to claim 6, wherein the cladding index of refraction n_{c} is disposed along a coupling length 2Lo, and the cladding with index of refraction n_{cb} is disposed in an area outside the length 2Lo.

8. Apparatus according to claim 7, wherein Lo is less than or equal to 100 um.

9. Apparatus according to claim 7, wherein the first waveguide core has an index of refraction n_{w}, and wherein n_{w}−n_{c} is less than or equal to 0.01, and n_{w}−n_{cb} is less than or equal to 0.1.

10. Apparatus according to claim 1, further comprising N first waveguides and N second waveguides, and further comprising 2N control lines for applying relative voltages to the voltage application structure of each waveguide.

11. Apparatus according to claim 1, wherein the first waveguide core/cladding structure is configured to provide a non-volatile memory function.

12. Apparatus according to claim 1, wherein the first waveguide core/cladding structure is configured to be substantially transparent to wavelengths of 0.5 -4 um, and to possess hysteresis with respect to voltage when a spontaneous polarization direction is reversed by an applied voltage.

13. Apparatus according to claim 1, wherein the first waveguide comprises a PZT core and a PLZT cladding, both disposed on an ST substrate.

14. An optical switching array, comprising:
a plurality of first waveguides, each said first waveguide having a core and a cladding;
a plurality of second waveguides respectively disposed within optical coupling distance of the first plurality of first waveguides, each said second waveguide having a core and a cladding;
optical coupling structure disposed adjacent each of said plurality of first waveguides and each of said plurality of second waveguides, for selectively applying voltage to said each of said plurality of first waveguide core and cladding, and to said each of said plurality of second waveguide core and cladding, to cause optical power propagating in said each first waveguide to be switched into an adjacent second waveguide; and
each said first waveguide having a core and a cladding configured to provide a memory function at a location where the optical power switches from said each first waveguide to the adjacent second waveguide.

15. An array according to claim 14, wherein the memory function comprises a ferro-electric memory function, and wherein each said first waveguide core comprises one of (i) PZT, (ii) PLZT, and (iii) ST.

16. An array according to claim 14, wherein the memory function is provided by a phase difference between (i) optical coupling structure adjacent each of said plurality of first waveguides, and (ii) optical coupling structure adjacent each of a respectively corresponding one of said plurality of second waveguides.

17. An array according to claim 16, wherein the phase difference is based on a bi-stable electro-optic effect.

18. An array according to claim 14, wherein the second plurality of waveguides is disposed horizontally adjacent to the first plurality of waveguides.

19. An array according to claim 14, wherein the second plurality of waveguides is disposed vertically adjacent the first plurality of waveguides.

20. An array according to claim 14, wherein each of the plurality of first waveguides comprises a PZT core and a PLZT cladding, disposed on a common substrate.

21. An array according to claim 20, wherein the common substrate comprises one of ST, Al₂O₃, and Si.

22. An array according to claim 14, wherein said plurality of first waveguides comprises 100 waveguides, and wherein said plurality of second waveguides comprises 100 waveguides.

23. An array according to claim 14, wherein the plurality of first waveguides, the plurality of second waveguides, and the optical coupling structure are disposed on a common substrate .

24. An optical switch, comprising:
a first optical waveguide having a core and a cladding;
a second optical waveguide having a core and a cladding;
a segmented optical waveguide having a core and a cladding and being disposed adjacent both said first optical waveguide and said second optical waveguide, said segmented optical waveguide comprising a first cladding with an index of refraction n_{cb} and a second cladding with an index of refraction n_{c}; and
coupler structure for applying a switching voltage to said segmented optical waveguide which causes a change in the segmented optical waveguide second cladding iindex of refraction n_{c} to cause optical power propagating in the first waveguide to be switched into the segmented waveguide and to be switched from the segmented waveguide into the second waveguide;
each of said first optical waveguide core, said second optical waveguide core, and said a segmented optical waveguide core comprising one of PZT, PLZT, and BST.

25. A switch according to claim 24, wherein the coupler structure applies a switching voltage having a power less than or equal to one microwatt.

26. An optical switch according to claim 24, wherein a refractive index difference between the core/cladding of the segmented optical waveguide is less than or equal to 1 percent.

27. An optical switch according to claim 24, wherein the segmented optical waveguide has a bend with a bend radius of less than or equal to 0.2 mm.

28. An optical switch according to claim 24, wherein said optical switch comprises a planar structure.

29. Apparatus according to claim 24, wherein the core/cladding of the first optical waveguide, the second optical waveguide, and the segmented optical waveguide are configured to provide a memory function whereby the optical power remains propagating from the first optical waveguide to the segmented optical waveguide to the second optical waveguide when said coupler structure provides a voltage which is less than the switching voltage.

30. An optical switch according to claim 29, wherein the core and the cladding of each of the first optical waveguide, the second optical waveguide, and the segmented optical waveguide, comprises an epitaxial layer.

31. Apparatus for switching an optical signal from a first waveguide into a second waveguide, comprising:
means for applying a differential voltage to the first waveguide to cause an optical signal propagating in the first waveguide to propagate in the second waveguide; and
the first waveguide having core/cladding means for providing a memory function that substantially maintains the propagation of the optical signal from the first waveguide to the second waveguide after the means for applying a voltage no longer applies the differential voltage to the first waveguide.

32. Apparatus according to claim 31, wherein, after the means for applying a voltage no longer applies the differential voltage to the first waveguide, the means for applying a voltage applies a sustaining voltage to the first waveguide to maintain the propagation of the light signal from the first waveguide to the second waveguide, wherein the sustaining voltage is less than the differential voltage.

33. Apparatus according to claim 31, wherein each of the first and second waveguides comprises a PZT core and a PLZT cladding.

34. Apparatus according to claim 33, wherein said means for applying a voltage comprises a coupler disposed adjacent each of said first and second waveguides, each coupler comprising top and bottom metal electrodes respectively disposed on opposite sides of the PLZT cladding.

35. Apparatus according to claim 34, wherein the PZT core and the PLZT cladding each comprises an epitaxial layer.

36. Apparatus according to claim 1, wherein the first waveguide includes two cladding regions which have different indices of refraction nc and n_{cb}.

37. Apparatus according to claim 36, wherein the cladding index of refraction n_{c} is disposed along a coupling length Lo, and the cladding with index of refraction n_{cb} is disposed in an area outside a length 2Lo.

38. Apparatus according to claim 37, wherein Lo is less than or equal to 100 um.

39. Apparatus according to claim 37, wherein the first waveguide core has an index of refraction n_{w}, and wherein n_{w}-n_{c} is less than or equal to 0.01, and n_{w}−n_{cb} is less than or equal to 0.1.

40. Apparatus according to claim 31, further comprising N first waveguides and N second waveguides, and further comprising 2N control lines for applying relative voltages to the voltage application structure of each waveguide.

41. Apparatus according to claim 31, wherein the first waveguide core/cladding means provides a non-volatile memory function.

42. Apparatus according to claim 31, wherein the first waveguide core/cladding means is configured to be substantially transparent to wavelengths of 0.5-4 um, and to possess hysteresis with respect to voltage when a spontaneous polarization direction is reversed by an applied voltage.

43. Apparatus according to claim 31, wherein the first waveguide comprises a PZT core and a PLZT cladding, both disposed on an ST substrate.

44. An optical switching array, comprising:
a plurality of first waveguides, each said first waveguide having a core and a cladding;
a plurality of second waveguides respectively disposed within optical coupling distance of the first plurality of first waveguides, each said second waveguide having a core and a cladding;
optical coupling means, disposed adjacent each of said plurality of first waveguides and each of said plurality of second waveguides, for selectively applying voltage to said each of said plurality of first waveguide core and cladding, and to said each of said plurality of second waveguide core and cladding, to cause optical power propagating in said each first waveguide to be switched into an adjacent second waveguide; and
each said first waveguide having a core/cladding means for providing a memory function at a location where the optical power switches from said each first waveguide to the adjacent second waveguide.

45. An array according to claim 44, wherein the memory function comprises a ferro-electric memory function, and wherein each said first waveguide core comprises one of (i) PZT, (ii) PLZT, and (iii) ST.

46. An array according to claim 44, wherein the memory function is provided by a phase difference between (i) optical coupling means adjacent each of said plurality of first waveguides, and (ii) optical coupling means adjacent each of a respectively corresponding one of said plurality of second waveguides.

47. An array according to claim 46, wherein the phase difference is based on a bi-stable electro-optic effect.

48. An array according to claim 44, wherein the second plurality of waveguides is disposed horizontally adjacent to the first plurality of waveguides.

49. An array according to claim 44, wherein the second plurality of waveguides is disposed vertically adjacent the first plurality of waveguides.

50. An array according to claim 44, wherein each of the plurality of first waveguides comprises a PZT core and a PLZT cladding, disposed on a common substrate.

51. An array according to claim 50, wherein the common substrate comprises one of ST, Al₂O₃, and Si.

52. An array according to claim 44, wherein said plurality of first waveguides comprises 100 waveguides, and wherein said plurality of second waveguides comprises 100 waveguides.

53. An array according to claim 44, wherein the plurality of first waveguides, the plurality of second waveguides, and the optical coupling structure are disposed on a common substrate .

54. An optical switch, comprising:
first optical waveguide means having a core and a cladding, for propagating optical power therein;
second optical waveguide means having a core and a cladding, for propagating optical power therein;
segmented optical waveguide means having a core and a cladding, for propagating optical power therein, and being disposed adjacent both said first optical waveguide means and said second optical waveguide means, said segmented optical waveguide means comprising a first cladding with an index of refraction n_{cb} and a second cladding with an index of refraction n_{c}; and
coupler means for applying a switching voltage to said segmented optical waveguide which causes a change in the segmented optical waveguide means second cladding iindex of refraction n_{c} to cause optical power propagating in the first waveguide means to be switched into the segmented waveguide means and to be switched from the segmented waveguide means into the second waveguide means;
each of said first optical waveguide means core, said second optical waveguide means core, and said a segmented optical waveguide means core comprising one of PZT, PLZT, and BST.

55. A switch according to claim 54, wherein the coupler means applies a switching voltage having a power less than or equal to one microwatt.

56. An optical switch according to claim 54, wherein a refractive index difference between the core/cladding of the segmented optical waveguide means is less than or equal to 1 percent.

57. An optical switch according to claim 54, wherein the segmented optical waveguide means has a bend with a bend radius of less than or equal to 0.2 mm.

58. An optical switch according to claim 54, wherein said optical switch comprises a planar structure.

59. Apparatus according to claim 54, wherein the core/cladding of the first optical waveguide means, the second optical waveguide means, and the segmented optical waveguide means are configured to provide a memory function whereby the optical power remains propagating from the first optical waveguide means to the segmented optical waveguide means to the second optical waveguide means when said coupler means provides a voltage which is less than the switching voltage.

60. An optical switch according to claim 29, wherein the core and the cladding of each of the first optical waveguide means, the second optical waveguide means, and the segmented optical waveguide means, comprises an epitaxial layer.

61. A method for switching an optical signal from a first waveguide into a second waveguide, the first waveguide and the second waveguide each having a core/cladding, the method comprising the steps of:
applying a differential voltage to the first waveguide to cause an optical signal propagating in the first waveguide to propagate in the second waveguide; and
configuring the first waveguide core/cladding so as to provide a memory function that substantially maintains the propagation of the optical signal from the first waveguide to the second waveguide after the applying voltage step no longer applies the differential voltage to the first waveguide.

62. A method according to claim 61, further comprising, after the applying voltage step no longer applies the differential voltage to the first waveguide, the step of applying a sustaining voltage to the first waveguide to maintain the propagation of the light signal from the first waveguide to the second waveguide, wherein the sustaining voltage is less than the differential voltage.

63. A method according to claim 61, wherein each of the first and second waveguides comprises a PZT core and a PLZT cladding.

64. A method according to claim 63, wherein the applying voltage step comprises the step of applying voltage to couplers disposed adjacent each of said first and second waveguides, each coupler comprising top and bottom metal electrodes respectively disposed on opposite sides of the PLZT cladding.

65. A method according to claim 64, wherein the PZT core and the PLZT cladding each comprises an epitaxial layer.

66. A method according to claim 61, wherein the first waveguide includes two cladding regions which have different indices of refraction n_{c} and n_{cb}.

67. A method according to claim 66, wherein the cladding index of refraction n_{c} is disposed along a coupling length 2Lo, and the cladding with index of refraction n_{cb} is disposed in an area outside the length 2Lo.

68. A method according to claim 67, wherein Lo is less than or equal to 100 um.

69. A method according to claim 67, wherein the first waveguide core has an index of refraction n_{w}, and wherein n_{w}−n_{c} is less than or equal to 0.01, and n_{w}-n_{cb} is less than or equal to 0.1.

70. A method according to claim 61, further comprising the step of providing N first waveguides and N second waveguides, and further comprising the step of providing N² control lines for applying relative voltages to the voltage application structure of each waveguide.

71. A method according to claim 61, wherein the step of configuring the first waveguide core/cladding includes the step of configuring the first waveguide core/cladding so as to provide a non-volatile memory function.

72. A method according to claim 61, wherein the step of configuring the first waveguide core/cladding includes the step of configuring the first waveguide core/cladding so as to be substantially transparent to wavelengths of 0.5-4 um, and to possess hysteresis with respect to voltage when a spontaneous polarization direction is reversed by an applied voltage.

73. A method according to claim 61, wherein the first waveguide comprises a PZT core and a PLZT cladding, both disposed on an ST substrate.

74. A method of switching optical power in an optical switching array, comprising the steps of:
providing a plurality of first waveguides, each said first waveguide having a core and a cladding;
providing a plurality of second waveguides respectively disposed within optical coupling distance of the first plurality of first waveguides, each said second waveguide having a core and a cladding;
providing optical coupling means, disposed adjacent each of said plurality of first waveguides and each of said plurality of second waveguides selectively applying voltage to said each of said plurality of first waveguide core and cladding, and to said each of said plurality of second waveguide core and cladding, to cause optical power propagating in said each first waveguide to be switched into an adjacent second waveguide; and
providing each said first waveguide with a core/cladding means for providing a memory function at a location where the optical power switches from said each first waveguide to the adjacent second waveguide.

75. A method according to claim 74, wherein the memory function comprises a ferro-electric memory function, and wherein each said first waveguide core comprises one of (i) PZT, (ii) PLZT, and (iii) ST.

76. A method according to claim 74, wherein the memory function is provided by a phase difference between (i) optical coupling means adjacent each of said plurality of first waveguides, and (ii) optical coupling means adjacent each of a respectively corresponding one of said plurality of second waveguides.

77. An array according to claim 46, wherein the phase difference is based on a bi-stable electro-optic effect.

78. A method according to claim 74, wherein the second plurality of waveguides is disposed horizontally adjacent to the first plurality of waveguides.

79. A method according to claim 74, wherein the second plurality of waveguides is disposed vertically adjacent the first plurality of waveguides.

80. A method according to claim 74, wherein each of the plurality of first waveguides comprises a PZT core and a PLZT cladding, disposed on a common substrate.

81. A method according to claim 80, wherein the common substrate comprises one of ST, Al₂O₃, and Si.

82. A method according to claim 74, wherein said plurality of first waveguides comprises 100 waveguides, and wherein said plurality of second waveguides comprises 100 waveguides.

83. A method according to claim 74, wherein the plurality of first waveguides, the plurality of second waveguides, and the optical coupling structure are disposed on a common substrate .

84. An optical switching process, comprising the steps of:
propagating optical power in a first optical waveguide, which has a core and a cladding;
disposing a second optical waveguide adjacent the first optical waveguide, the second optical waveguide having a core and a cladding;
disposing a segmented optical waveguide adjacent the first optical waveguide and the second optical waveguide, the segmented optical waveguide having a core and a cladding, said segmented optical waveguide comprising a first cladding with an index of refraction n_{cb} and a second cladding with an index of refraction n_{c};
a coupler step for applying a switching voltage to said segmented optical waveguide which causes a change in the segmented optical waveguide second cladding index of refraction nc to cause the optical power propagating in the first waveguide to be switched into the segmented waveguide and to be switched from the segmented waveguide into the second waveguide; and
configuring each of said first optical waveguide core, said second optical waveguide core, and said a segmented optical waveguide core to comprise one of PZT, PLZT, and BST.

85. A process according to claim 84, wherein the coupler step applies a switching voltage having a power less than or equal to one microwatt.

86. A process according to claim 84, wherein a refractive index difference between the core/cladding of the segmented optical waveguide is less than or equal to 1 percent.

87. A process according to claim 84, wherein the segmented optical waveguide has a bend with a bend radius of less than or equal to 0.2 mm.

88. A process according to claim 84, wherein each of said first optical waveguide, said second optical waveguide, and said a segmented optical waveguide comprises a planar structure.

89. A process according to claim 84, wherein the core/cladding of the first optical waveguide, the second optical waveguide, and the segmented optical waveguide means are configured to provide a memory function whereby the optical power remains propagating from the first optical waveguide to the segmented optical waveguide to the second optical waveguide when said coupler step provides a voltage which is less than the switching voltage.

90. A process according to claim 89, wherein the core and the cladding of each of the first optical waveguide, the second optical waveguide, and the segmented optical waveguide, comprises an epitaxial layer.

91. A process of forming an optical switch which switches optical power from a first waveguide among a plurality of first waveguides to a second waveguide among a plurality of second waveguides, comprising the steps of:
layering a first metal electrode array pattern on the substrate;
layering a first cladding layer array pattern on the substrate over the first metal electrode layer;
layering a core layer array pattern on the substrate over the first cladding layer;
layering a second cladding layer array pattern on the substrate over the core layer;
layering a second metal electrode array pattern on the substrate over the second cladding layer; and
configuring the first and second cladding layers and the core layer to cause a memory function at cross points of the first and second waveguides to cause optical power switched from the first waveguide to the second waveguide to remain propagating in the second waveguide after a switching voltage has been reduced.

92. A process according to claim 91, wherein each layering step comprises an epitaxial deposition step.

93. A process according to claim 91, wherein the cladding layering steps each comprise the step of layering a PZT layer, and wherein the core layering step comprises the step of layering one of PLZT and BST.

94. A process according to claim 91, wherein the layering steps layer the plurality of first waveguides, the plurality of second waveguides, and a plurality of segmented waveguides.

95. A process according to claim 94, wherein the segmented waveguides are disposed vertically adjacent the second waveguides.

96. A process according to claim 91, wherein the layering steps layer 1 000 first waveguides and 1000 second waveguides on a common substrate.

97. An optical switch comprising:
a first waveguide having a core and a cladding;
a second waveguide having a core and a cladding, an optical coupling length between the first waveguide and the second waveguide being defined as Lo; and
switching structure that applies a voltage to said first waveguide to cause a light signal propagating therein to be switched to the second waveguide at a distance 2Lo along the first waveguide.

98. An optical switch according to claim 97, wherein said first waveguide core and cladding, and said second waveguide core and cladding are predetermined to cause the light signal to continue propagating in the first waveguide in the absence of said switching structure applying said voltage.

99. An optical switch according to claim 98, wherein the second waveguide is disposed at a right angle with respect to the first waveguide, and wherein said switching structure causes the light signal propagating along a light transmission path in the first waveguide to switch to the second waveguide and travel along a light transmission path therein that is at a right angle with respect to the light transmission path of the first waveguide, when the switching structure applies said voltage.
